(19) United States
(12) Patent Application Publication
(10) Pub. No.: US 2015/0248694 A1
(43) Pub. Date: Sep. 3, 2015

(54) ATTRIBUTING OFFLINE PURCHASES TO ONLINE ADVERTISING

(71) Applicant: Prakash Chandra, Fremont, CA (US)

(72) Inventor: Prakash Chandra, Fremont, CA (US)

(73) Assignee: EBAY INC., SAN JOSE, CA (US)

(21) Appl. No.: 14/194,197

(22) Filed: Feb. 28, 2014

(51) Int. Cl. G06Q 30/02

(52) U.S. Cl. CPC G06Q 30/0246; G06Q 30/0277

(57) ABSTRACT

A system and method of attributing offline purchases to online advertising are described. In some embodiments, advertisement information comprising identifying information of an online advertisement for a product or brand of products, identifying information of recipients of the online advertisement, and a corresponding advertisement time at which the online advertisement was provided to each of recipients is received. Purchase information for offline purchases corresponding to at least one brick- and mortar retailer is also received. The purchase information comprises identifying information of a corresponding purchaser for each purchase, identifying information of a corresponding product or brand of products for each purchase, and a corresponding purchase time at which each purchase was made. One of the purchasers is identified as one of the recipients based on a determined match between their corresponding identifying information. At least one of the purchases of the identified purchaser is associated with the online advertisement.

### TECHNICAL FIELD

The present application relates generally to the technical field of data processing, and, in various embodiments, to systems and methods of attributing offline purchases to online advertising.

### BACKGROUND

The effects of online advertising on offline purchases are often overlooked. Accurately attributing offline purchases to a particular online advertisement or online advertisement campaign can be difficult.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a block diagram depicting a network architecture of a system having a client-server architecture configured for exchanging data over a network, in accordance with some embodiments;

FIG. 2 is a block diagram depicting various components of a network-based publication system, in accordance with some embodiments;

FIG. 3 is a block diagram depicting various tables that may be maintained within a database, in accordance with some embodiments;

FIG. 4 is a block diagram illustrating components of a system for attributing offline purchases with online advertisements, in accordance with some embodiments;

FIG. 5 illustrates advertisement information, in accordance with some embodiments;

FIG. 6 illustrates purchase information, in accordance with some embodiments;

FIG. 7 illustrates a mapping of associations between offline purchases and online advertisements, in accordance with some embodiments;

FIG. 8 illustrates a human-readable report indicating an association between offline purchases and an online advertisement;

FIG. 9 is a flowchart illustrating a method of attributing offline purchases with online advertisements, in accordance with some embodiments;

FIG. 10 is a flowchart illustrating a method of attributing offline purchases with online advertisements, in accordance with some embodiments; and

FIG. 11 shows a diagrammatic representation of a machine in the example form of a computer system within which a set of instructions may be executed to cause the machine to perform any one or more of the methodologies discussed herein, in accordance with some embodiments.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

The present disclosure describes systems and methods of attributing offline purchases to online advertising. In some embodiments, advertisement information is received. The advertisement information may comprise identifying information of an online advertisement for a product or a brand of products, identifying information of a plurality of recipients of the online advertisement, and a corresponding advertisement time at which the online advertisement was provided to each one of the plurality of recipients. Purchase information for a plurality of offline purchases corresponding to at least one brick- and mortar retailer can also be received. The purchase information may comprise identifying information of a corresponding purchaser for each one of the plurality of offline purchases, identifying information of a corresponding product or brand of products for each one of the plurality of offline purchases, and a corresponding purchase time at which each one of the plurality of offline purchases was made. One of the purchasers can be identified as one of the recipients based on a determined match between their corresponding identifying information. At least one of the plurality of purchases of the identified purchaser can be associated with the online advertisement based on a determination that the corresponding product of the purchase(s) corresponds to the product or brand of products of the online advertisement, and a determination that the corresponding purchase time of the purchase(s) was after the corresponding advertisement time of the online advertisement, or otherwise within a predefined period of time.

In some embodiments, the identifying information of each recipient comprises a physical address and the identifying information of each purchaser comprises a physical address. In some embodiments, the association between the at least one of the purchases of the identified purchaser with the at least one online advertisement is stored in a database. In some embodiments, a human-readable report indicating the association between the purchase(s) of the identified purchaser with the online advertisement is generated. In some embodiments, the purchase information for the plurality of offline purchases is received from the corresponding at least one brick- and mortar retailer.

In some embodiments, an advertising campaign is modified based on the association between the purchase(s) of the identified purchaser with the online advertisement. In some embodiments modifying the advertising campaign comprises increasing a number of recipients to which the online advertisement is to be provided.

In some embodiments, a first group of the plurality of purchasers that were provided the online advertisement is identified, and a second group of the plurality of purchasers that were not provided the online advertisement is identified. Pre-advertisement purchase behavior with respect to the product or the brand of products for the first group and the second group of purchasers corresponding to a period of time before the online advertisement was provided to the first group of purchasers can be determined, and post-advertisement purchase behavior with respect to the product or the brand of products for the first group and the second group of purchasers corresponding to a period of time after the online advertisement was provided to the second group of purchasers can be determined. A change between the pre-advertisement purchase behavior of the first group of purchasers and the post-advertisement purchase behavior of the first group of purchasers can be determined, and a change between the pre-advertisement purchase behavior of the second group of purchasers and the post-advertisement purchase behavior of the second group of purchasers can be determined. A difference between the change of the first group of purchasers and the change of the second group of purchasers can be identified. In some embodiments, the change of the second group is subtracted from the change of the first group, thereby generating an adjusted change of the first group.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

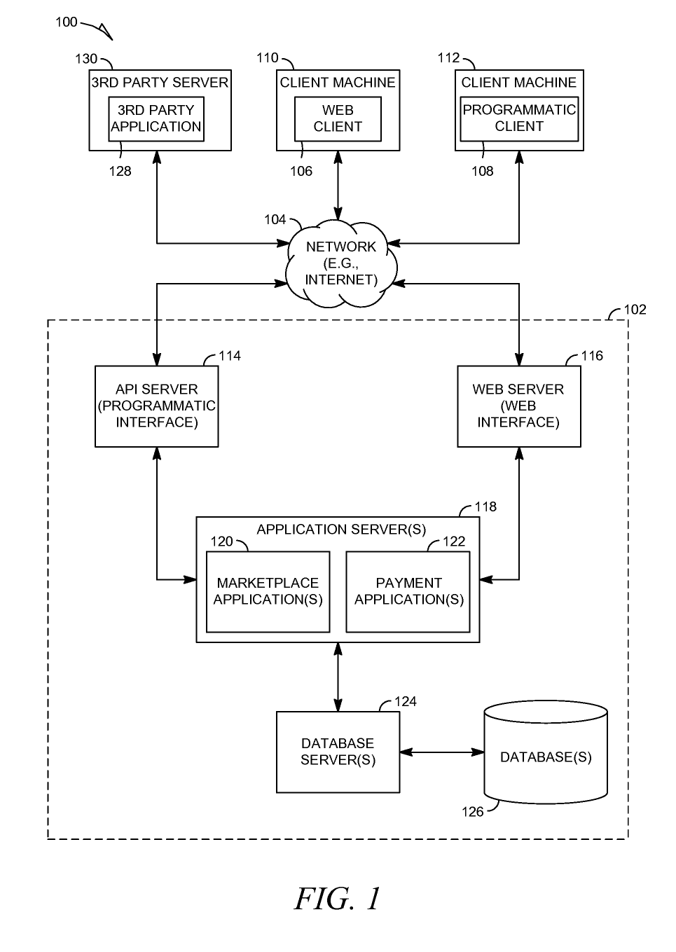

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or a Wide Area Network (WAN)) to one or more clients. FIG. 1 illustrates, for example, a web client 106 (e.g., a browser, such as the Internet Explorer browser developed by Microsoft Corporation of Redmond, Wash. State) and a programmatic client 108 executing on respective client machines 110 and 112.

An API server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 may provide a number of marketplace functions and services to users who access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the embodiments are, of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

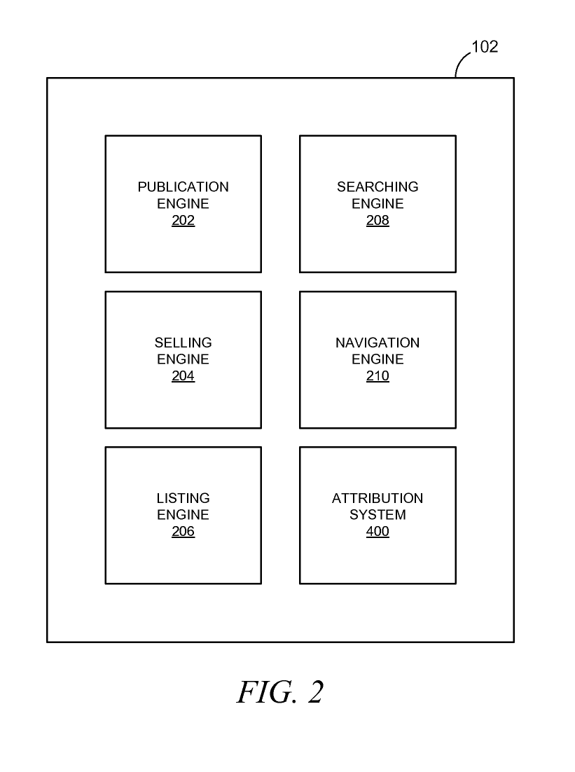

FIG. 2 illustrates a block diagram showing components provided within the networked system 102 according to some embodiments. The networked system 102 may be hosted on dedicated or shared server machines (not shown) that are communicatively coupled to enable communications between server machines. The components themselves are communicatively coupled (e.g., via appropriate interfaces) to each other and to various data sources, so as to allow information to be passed between the applications or so as to allow the applications to share and access common data. Furthermore, the components may access one or more databases 126 via the database servers 124.

The networked system 102 may provide a number of publishing, listing, and/or price-setting mechanisms whereby a seller (also referred to as a first user) may list (or publish information concerning) goods or services for sale or barter, a buyer (also referred to as a second user) can express interest in or indicate a desire to purchase or barter such goods or services, and a transaction (such as a trade) may be completed pertaining to the goods or services. To this end, the networked system 102 may comprise at least one publication engine 202 and one or more selling engines 204. The publication engine 202 may publish information, such as item listings or product description pages, on the networked system 102. In some embodiments, the selling engines 204 may comprise one or more fixed-price engines that support fixed-price listing and price setting mechanisms and one or more auction engines that support auction-format listing and price setting mechanisms (e.g., English, Dutch, Chinese, Double, Reverse auctions, etc.). The various auction engines may also provide a number of features in support of these auction-format listings, such as a reserve price feature whereby a seller may specify a reserve price in connection with a listing and a proxy-bidding feature whereby a bidder may invoke automated proxy bidding. The selling engines 204 may further comprise one or more deal engines that support merchant-generated offers for products and services.

A listing engine 206 allows sellers to conveniently author listings of items or authors to author publications. In one embodiment, the listings pertain to goods or services that a user (e.g., a seller) wishes to transact via the networked system 102. In some embodiments, the listings may be an offer, deal, coupon, or discount for the good or service. Each good or service is associated with a particular category. The listing engine 206 may receive listing data such as title, description, and aspect name/value pairs. Furthermore, each listing for a good or service may be assigned an item identifier. In other embodiments, a user may create a listing that is an advertisement or other form of information publication. The listing information may then be stored to one or more storage devices coupled to the networked system 102 (e.g., databases 126). Listings also may comprise product description pages that display a product and information (e.g., product title, specifications, and reviews) associated with the product. In some embodiments, the product description page may include an aggregation of item listings that correspond to the product described on the product description page.

The listing engine 206 may also allow buyers to conveniently author listings or requests for items desired to be purchased. In some embodiments, the listings may pertain to goods or services that a user (e.g., a buyer) wishes to transact via the networked system 102. Each good or service is associated with a particular category. The listing engine 206 may receive as much or as little listing data, such as title, description, and aspect name/value pairs, that the buyer is aware of about the requested item. In some embodiments, the listing engine 206 may parse the buyer's submitted item information and may complete incomplete portions of the listing. For example, if the buyer provides a brief description of a requested item, the listing engine 206 may parse the description, extract key terms and use those terms to make a determination of the identity of the item. Using the determined item identity, the listing engine 206 may retrieve additional item details for inclusion in the buyer item request. In some embodiments, the listing engine 206 may assign an item identifier to each listing for a good or service.

In some embodiments, the listing engine 206 allows sellers to generate offers for discounts on products or services. The listing engine 206 may receive listing data, such as the product or service being offered, a price and/or discount for the product or service, a time period for which the offer is valid, and so forth. In some embodiments, the listing engine 206 permits sellers to generate offers from the sellers' mobile devices. The generated offers may be uploaded to the networked system 102 for storage and tracking.

Searching the networked system 102 is facilitated by a searching engine 208. For example, the searching engine 208 enables keyword queries of listings published via the networked system 102. In example embodiments, the searching engine 208 receives the keyword queries from a device of a user and conducts a review of the storage device storing the listing information. The review will enable compilation of a result set of listings that may be sorted and returned to the client device (e.g., device machine 110, 112) of the user. The searching engine 208 may record the query (e.g., keywords) and any subsequent user actions and behaviors (e.g., navigations).

The searching engine 208 also may perform a search based on the location of the user. A user may access the searching engine 208 via a mobile device and generate a search query. Using the search query and the user's location, the searching engine 208 may return relevant search results for products, services, offers, auctions, and so forth to the user. The searching engine 208 may identify relevant search results both in a list form and graphically on a map. Selection of a graphical indicator on the map may provide additional details regarding the selected search result. In some embodiments, the user may specify as part of the search query a radius or distance from the user's current location to limit search results.

The searching engine 208 also may perform a search based on an image. The image may be taken from a camera or imaging component of a client device or may be accessed from storage.

In a further example, a navigation engine 210 allows users to navigate through various categories, catalogs, or inventory data structures according to which listings may be classified within the networked system 102. For example, the navigation engine 210 allows a user to successively navigate down a category tree comprising a hierarchy of categories (e.g., the category tree structure) until a particular set of listings is reached. Various other navigation applications within the navigation engine 210 may be provided to supplement the searching and browsing applications. The navigation engine 210 may record the various user actions (e.g., clicks) performed by the user in order to navigate down the category tree.

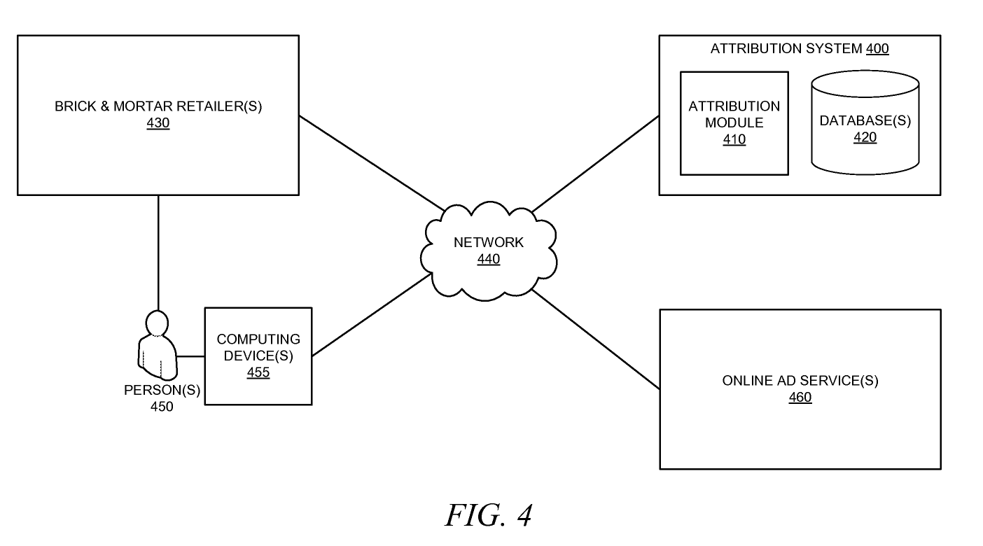

In some embodiments, an attribution system 400 may be configured to provide functionality for attributing offline purchases with online advertisements. The features, functions, and operations of the attribution system 410 will be discussed in further detail below with respect to FIGS. 4-10.

Additional modules and engines associated with the networked system 102 are described below in further detail. It should be appreciated that modules or engines may embody various aspects of the details described below.

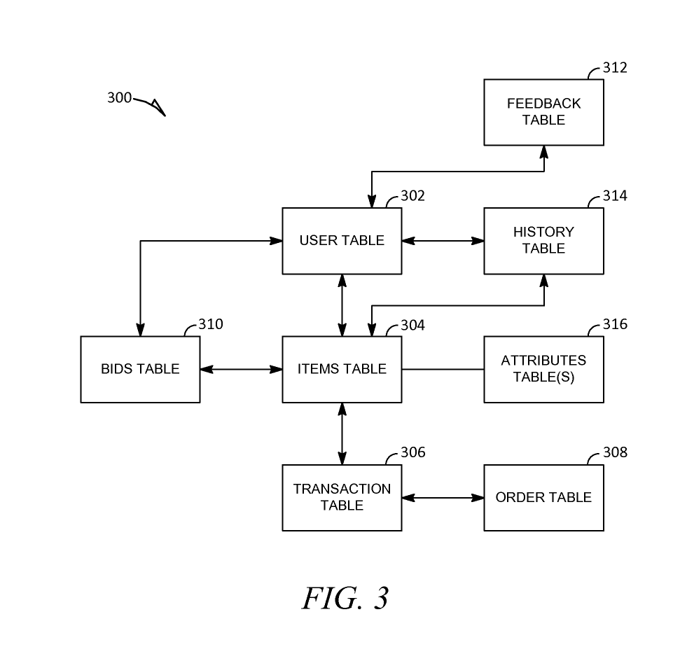

FIG. 3 is a high-level entity-relationship diagram, illustrating various tables 300 that may be maintained within the database(s) 126, and that are utilized by and support the applications 120 and 122. A user table 302 contains a record for each registered user of the networked system 102, and may include identifier, address and financial instrument information pertaining to each such registered user. A user may operate as a seller, a buyer, or both, within the networked system 102. In one example embodiment, a buyer may be a user that has accumulated value (e.g., commercial or proprietary currency), and is accordingly able to exchange the accumulated value for items that are offered for sale by the networked system 102.

The tables 300 also include an items table 304 in which are maintained item records for goods and services that are available to be, or have been, transacted via the networked system 102. Each item record within the items table 304 may furthermore be linked to one or more user records within the user table 302, so as to associate a seller and one or more actual or potential buyers with each item record.

A transaction table 306 contains a record for each transaction (e.g., a purchase or sale transaction) pertaining to items for which records exist within the items table 304.

An order table 308 is populated with order records, with each order record being associated with an order. Each order, in turn, may be associated with one or more transactions for which records exist within the transaction table 306.

Bid records within a bids table 310 each relate to a bid received at the networked system 102 in connection with an auction-format listing supported by an auction application. A feedback table 312 is utilized by one or more reputation applications, in one example embodiment, to construct and maintain reputation information concerning users. A history table 314 maintains a history of transactions to which a user has been a party. One or more attributes tables 316 record attribute information pertaining to items for which records exist within the items table 304. Considering only a single example of such an attribute, the attributes tables 316 may indicate a currency attribute associated with a particular item, with the currency attribute identifying the currency of a price for the relevant item as specified by a seller.

FIG. 4 is a block diagram illustrating components of attribution system 400, in accordance with some embodiments. Attribution system 400 is configured to attribute offline purchases with online advertisements. As mentioned above, attribution system 400 may be incorporated into, integrated with, or otherwise work and communicate with another system, such as networked system 102. Accordingly, attributions system may be incorporated into, integrated with, or otherwise work and communicate with a network-based marketplace (e.g., eBay®) or publication system. However, it is contemplated that other configurations of attribution system 400 are also within the scope of the present disclosure.

In some embodiments, attribution system 400 comprises attribution module 410. Attribution module 410 may be configured to receive advertisement information corresponding to one or more online advertisements provided to one or more persons 450 on one or more computing devices 455 and purchase information corresponding to one or more offline purchases made by one or more persons 450 at one or more brick-and-mortar retail stores 430. In some embodiments, a brick-and-mortar retail store 430 is a physical store having a physical presence of a building or other physical structure that is used for store operations (e.g., to sell products) and to provide face-to-face customer experiences, as opposed to an online store. It is contemplated that some retailers have both brick-and-mortar retail stores 430 as well as online stores (e.g., Target® has physical Target® stores and Target.com®).

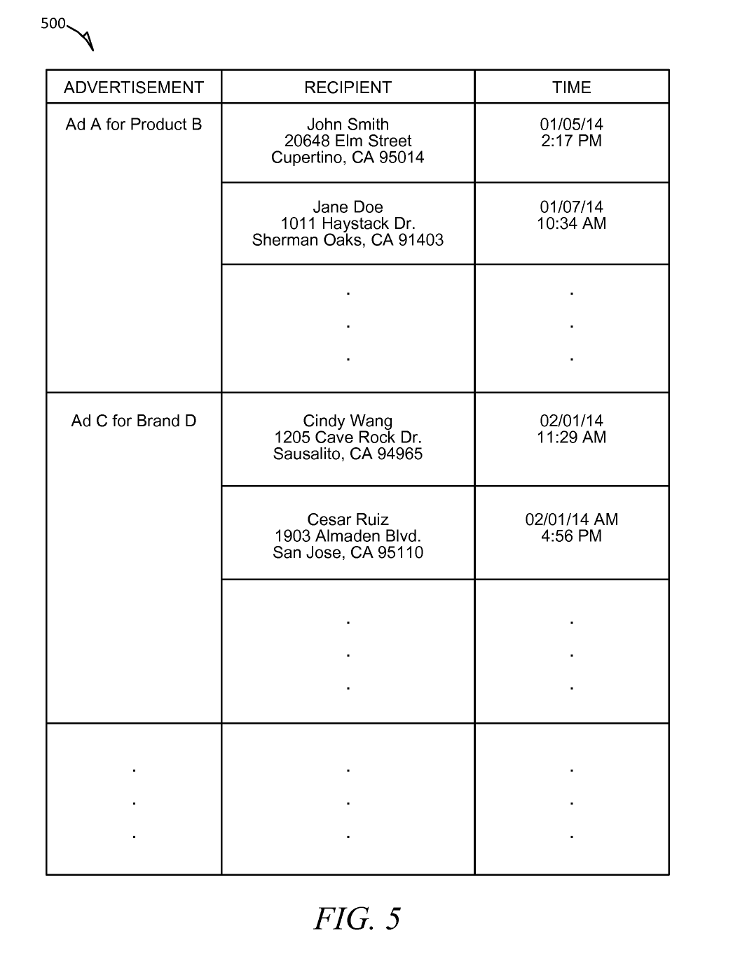

FIG. 5 illustrates advertisement information 500, in accordance with some embodiments. In some embodiments, advertisement information 500 comprises identifying information of at least one online advertisement for a product or a brand of products (e.g., Ad A for Product B, Ad C for Brand D, etc.), identifying information of recipients of the online advertisement, and a corresponding advertisement time (e.g., 01/05/14 at 2:17 PM, etc.) at which each online advertisement was provided to each one of the recipients. The identifying information of the recipients can include, but is not limited to, a name, a physical address (e.g., residential address or mailing address), a phone number, and/or an e-mail address. Other types of identifying information of the recipients are also within the scope of the present disclosure

Referring back to FIG. 4, the advertisements can be provided to the recipients (e.g., person(s) 450) by one or more online ad services 460. Ad service(s) 460 may comprise one or more ad servers configured to manage and implement the presentation of advertisements to people. Ad service(s) 460 can be part of the same system (e.g., controlled or managed by the same company or organization) as attribution module 410, or may be separate and independent from the system of attribution module 410. Ad service(s) 460 can determine what advertisements to provide to what people, and when to provide the advertisements to those people. Ad service(s) 460 can then provide the advertisements based on those determinations. Providing an advertisement can include, but is not limited to, causing the advertisement to be displayed on the recipient's computing device 455 while the recipient is viewing a page of a website or a mobile application, sending an e-mail including the advertisement to the recipient, and sending a text message including the advertisement to the recipient. Other techniques of providing advertisements to recipients are also within the scope of the present disclosure.

Any of the communication described herein between any of the systems, devices, databases, modules, services, websites, and retailers can be achieved via one or more networks 440. The network(s) 440 may include any network that enables communication between or among machines, databases, and devices. Accordingly, the network(s) may include a wired network, a wireless network (e.g., a mobile or cellular network), or any suitable combination thereof. The network(s) may include one or more portions that constitute a private network, a public network (e.g., the Internet), or any suitable combination thereof. Other configurations are also within the scope of the present disclosure.

In some embodiments, computing device(s) 455 can include, but is not limited to desktop computers, laptop computers, smart phones, and tablet computers. Other types of computing devices 455 are also within the scope of the present disclosure.

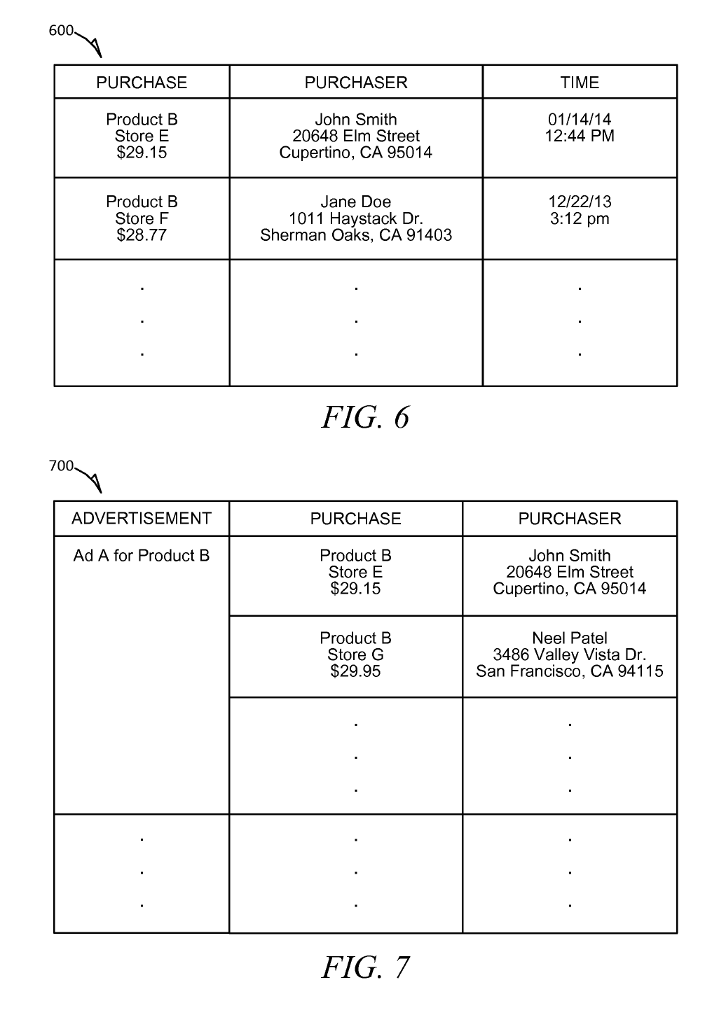

FIG. 6 illustrates purchase information 600, in accordance with some embodiments. In some embodiments, purchase information 600 comprises identifying information of a corresponding purchaser for each one of the plurality of offline purchases, identifying information of a corresponding product or brand of products for each one of the plurality of offline purchases (e.g., Product B, Brand D, etc.), and a corresponding purchase time at which each one of the plurality of offline purchases was made (e.g., 01/14/14 at 12:44 PM, etc.). The identifying information of the purchasers can include, but is not limited to, a name, a physical address (e.g., residential address or mailing address), a phone number, and/or an e-mail address. Other types of identifying information of the purchasers are also within the scope of the present disclosure.

The organization that owns, manages, or controls attribution system 400 can establish a relationship with brick-and-mortar retail stores 430 so that brick-and-mortar retail stores 430 provide purchase information 600 to attribution system 400. In some embodiments, attribution system 400 receives purchase information 600 from brick-and-mortar retail stores 430, as opposed to from the purchasers. Brick-and-mortar retail stores 430 can record purchase information 600, or a portion thereof, by processing loyalty cards used by purchasers during the purchase of products. Loyalty cards can provide identifying information of the purchaser, thus enabling brick-and-mortar retail stores 430 to keep track of purchases made by those purchasers using the loyalty cards. It is contemplated that other techniques of obtaining purchase information 600 are also within the scope of the present disclosure.

Although FIGS. 5 and 6 show the identifying information for the recipients and purchasers, respectively, as including a name, it is contemplated that, in some embodiments, the identifying information may be absent any name or may only comprise an address. Additionally, it is contemplated that more than one purchaser may have the same address. For example, in FIGS. 5-6, John Smith is shown as having an address of 20648 Elm Street, Cupertino, Calif. 95014. It is possible that John Smith may have a wife (e.g., Mary Smith) who lives with him, and thus has the same address. Furthermore, more than one person may share the same loyalty card, thus resulting in multiple people having the same identifying information, depending on what information is used as the identifying information.

In some embodiments, attribution module 410 is configured to determine a correlation between the presentation of the online advertisements to people and the offline purchases made by those people. Attribution module 410 can determine if any of the purchasers match any of the recipients based on a comparison of their corresponding identifying information. If a purchaser matches a recipient, then attribution module 410 can identify that purchaser as the recipient. As previously discussed, the identifying information of the recipient and the purchaser can include, but is not limited to, a name, a physical address (e.g., residential address or mailing address), a phone number, and/or an e-mail address.

Using a physical address as the identifying information that is compared to identify a purchaser as a recipient is particularly useful, as most people only have one physical address. In contrast, a significant number of people have multiple e-mail addresses. Attribution module 410 can take advantage of this one-to-one mapping of a physical address as identifying information for both the advertisement and the purchases in order to completely and accurately attribute offline purchases to online advertisements.

In some embodiments, for a matched purchaser/recipient pair (e.g., based on a matching of the corresponding identifying information), attribution module 410 is configured to determine if a product of the purchase(s) of the corresponding purchaser corresponds to the product or brand of products of the online advertisement provided to the corresponding recipient of the purchaser/recipient pair, as well as determine if the corresponding purchase time of the purchase(s) was after the corresponding advertisement time of the online advertisement (e.g., did the purchaser purchase the product after he or she was provided with the online advertisement). In some embodiments, attribution module 410 is configured to associate the offline purchase with the online advertisement based on a determination that the corresponding product of the purchase corresponds to the product or brand of products of the online advertisement, and a determination that the corresponding purchase time of the purchase was after the corresponding advertisement time of the online advertisement.

FIG. 7 illustrates a mapping 700 of associations between offline purchases and online advertisements, in accordance with some embodiments. FIG. 7 shows John Smith's purchase of Product B as being associated with Ad A for Product B based on the determination that John Smith purchased Product B (on 01/14/14 at 12:44 PM in FIG. 6) after being provided Ad A for Product B (on 01/05/14 at 2:17 PM in FIG. 5). As a contrasting example, Jane Doe's purchase of Product B on 12/22/13 at 3:12 PM (FIG. 6) may be prevented from being associated with Ad A for Product B, which she was provided on 01/07/14 (FIG. 5), since the purchase time preceded the advertisement time.

In some embodiments, the association of a purchase with an advertisement can be based on the satisfaction of a timing requirement with respect to the purchase time and the advertisement time. While a requirement that the purchase time be after the advertisement time has been discussed, it is contemplated that other timing requirements are also within the scope of the present disclosure. For example, in some embodiments, a timing requirement that the purchase time not occur beyond a specified amount of time after the advertisement time may be employed in order to account for a situation where the effectiveness of an advertisement has gone stale. In one example, attribution module 410 may be configured to avoid attributing a purchase to an advertisement if the purchase occurred more than one year after the advertisement was provided. The timing requirement may comprise a predefined period of time, which may be determined based on an average of historical information about expected conversion times for viewers of an ad for a product to be converted into purchasers of the product. This historical information can include expected conversion times for the same product, a similar product, or the same brand. Other examples and configurations are also within the scope of the present disclosure.

The associations 700 between offline purchases and online advertisements can be used for a variety of purposes and in a variety of further operations. In some embodiments, an online advertising campaign for a product or a brand of products can be modified based on one or more associations between the purchase behavior with respect to the product of brand of products and one or more online advertisements for the product or brand of products. For example, the online advertising campaign can be modified so that the number of recipients of the corresponding online advertisement(s) is increased or decreased, or so that the frequency of the corresponding online advertisement(s) is increased or decreased.

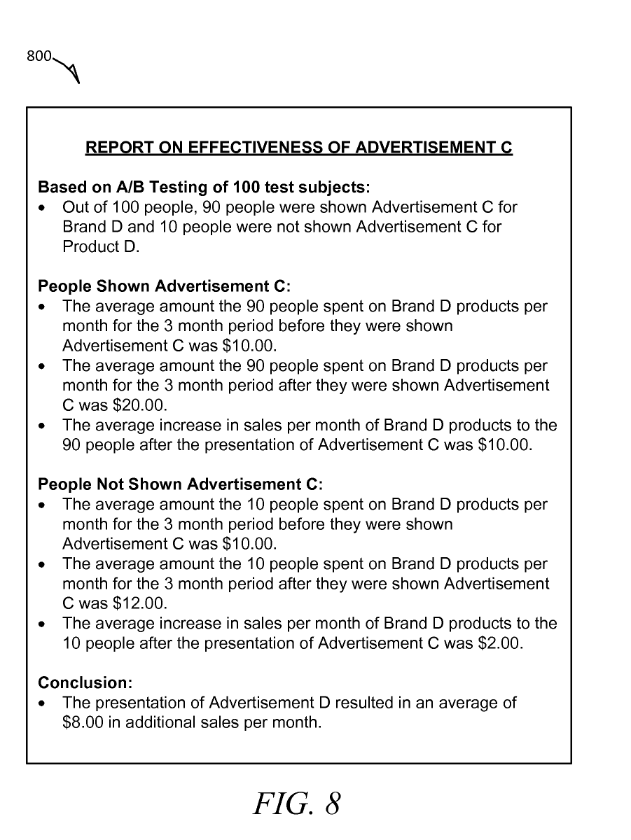

In some embodiments, attribution module 410 is configured to generate a human-readable report indicating the association between one or more offline purchases and one or more online advertisements. FIG. 8 illustrates a human-readable report 800 indicating an association between offline purchases and an online advertisement. In some embodiments, the effectiveness of an advertising campaign can be determined based on A/B testing. Human-readable report 800 comprises information about the effectiveness of Advertisement C for products of Brand D based on A/B testing involving associations between offline purchases of products of Brand D and Advertisement C. In such A/B testing, a first group of purchasers (e.g., 90 purchasers) were provided with an online advertisement for Brand C, while a second group of purchasers (e.g., 10 purchasers) were not provided with the online advertisement. The pre-advertisement purchase behavior of the first group (e.g., $10.00/month) and the second group ($10.00/month), with respect to Brand C products, corresponding to a period of time (e.g., 3-month period) before the online advertisement was provided to the first group of purchasers was determined. Similarly, the post-advertisement purchase behavior of the first group (e.g., $20.00/month) and the second group (e.g., $12.00), with respect to the Brand C products, corresponding to a period of time (e.g., 3-month period) after the online advertisement was provided to the second group of purchasers was determined.

A change (e.g., $10.00 increase) between the pre-advertisement purchase behavior of the first group of purchasers and the post-advertisement purchase behavior of the first group of purchasers was determined. Similarly, a change (e.g., $2.00 increase) between the pre-advertisement purchase behavior of the second group of purchasers and the post-advertisement purchase behavior of the second group of purchasers was determined. The effectiveness of Advertisement C (e.g., $8.00 in additional sales per month) is included in the human-readable report 800. This effectiveness can be determined by adjusting (e.g., offsetting) the change of the first group of purchasers based on the change of the second group of purchasers. For example, in the example shown in FIG. 8, since the average amount of sales for the second group also increased even though the purchasers in the second group were not provided Advertisement C, that increase in sales for the second group (e.g., $2.00) can be subtracted from the increase in sales for the first group (e.g., $10.00), thereby generating an adjusted change of the first group (e.g., $8.00).

Other types, forms, and examples of content for human-readable report 800 are also within the scope of the present disclosure.

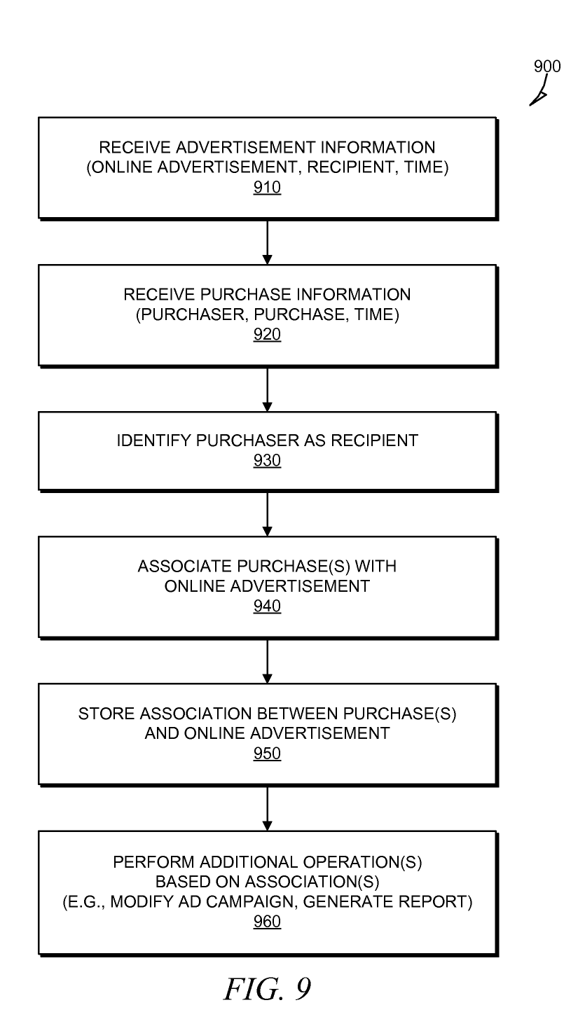

FIG. 9 is a flowchart illustrating a method 900 of attributing offline purchases with online advertisements, in accordance with some embodiments. The operations of method 900 may be performed by a system or modules of a system (e.g., attribution system 400 in FIG. 4).

At operation 910, advertisement information can be received. The advertisement information may comprise identifying information of an online advertisement for a product or a brand of products, identifying information of a plurality of recipients of the online advertisement, and a corresponding advertisement time at which the online advertisement was provided to each one of the plurality of recipients.

At operation 920, purchase information for a plurality of offline purchases corresponding to at least one brick- and mortar retailer can also be received. The purchase information may comprise identifying information of a corresponding purchaser for each one of the plurality of offline purchases, identifying information of a corresponding product or brand of products for each one of the plurality of offline purchases, and a corresponding purchase time at which each one of the plurality of offline purchases was made.

At operation 930, one of the purchasers can be identified as one of the recipients based on a determined match between their corresponding identifying information.

At operation 940, at least one of the plurality of purchases of the identified purchaser can be associated with the online advertisement based on a determination that the corresponding product of the purchase(s) corresponds to the product or brand of products of the online advertisement, and a determination that the corresponding purchase time of the purchase(s) was after the corresponding advertisement time of the online advertisement.

At operation 950, the association between the at least one of the purchases of the identified purchaser with the at least one online advertisement can be stored in a database.

At operation 960, one or more additional operations can be performed using the associations determined at operation 940. For example, in some embodiments, an advertising campaign is modified based on the association between the purchase(s) of the identified purchaser with the online advertisement. In some embodiments, a human-readable report indicating the association between the purchase(s) of the identified purchaser with the online advertisement is generated.

It is contemplated that the operations of method 900 may incorporate any of the other features disclosed herein.

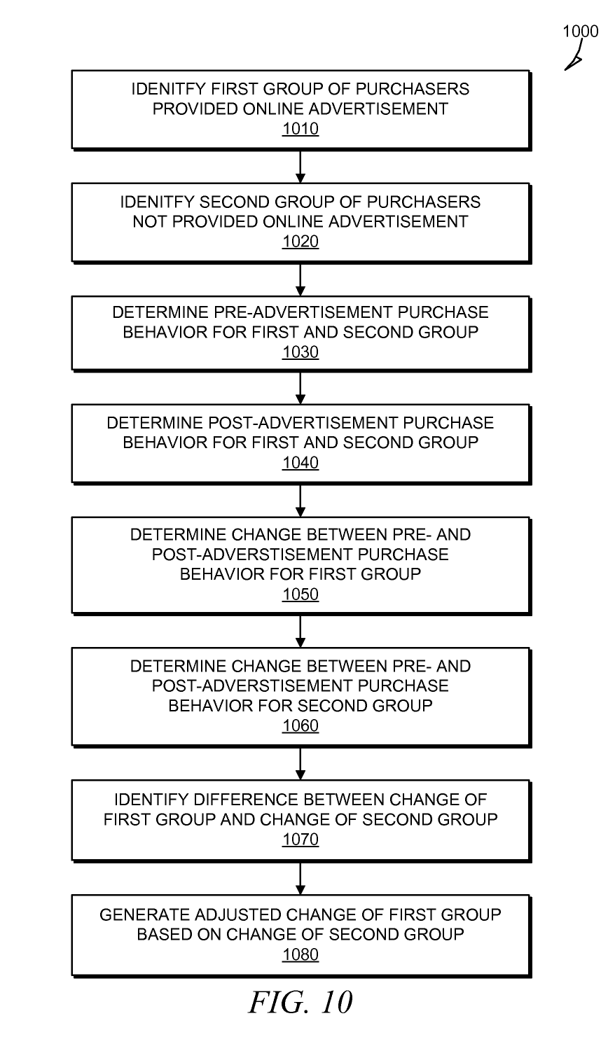

FIG. 10 is a flowchart illustrating a method 1000 of attributing offline purchases with online advertisements, in accordance with some embodiments. The operations of method 1000 may be performed by a system or modules of a system (e.g., attribution system 400 in FIG. 4).

At operation 1010, a first group of the plurality of purchasers that were provided the online advertisement can be identified.

At operation 1020, a second group of the plurality of purchasers that were not provided the online advertisement can be identified.

At operation 1030, pre-advertisement purchase behavior with respect to the product or the brand of products for the first group and the second group of purchasers corresponding to a period of time before the online advertisement was provided to the first group of purchasers can be determined.

At operation 1040, post-advertisement purchase behavior with respect to the product or the brand of products for the first group and the second group of purchasers corresponding to a period of time after the online advertisement was provided to the second group of purchasers can be determined.

At operation 1050, a change between the pre-advertisement purchase behavior of the first group of purchasers and the post-advertisement purchase behavior of the first group of purchasers can be determined.

At operation 1060, a change between the pre-advertisement purchase behavior of the second group of purchasers and the post-advertisement purchase behavior of the second group of purchasers can be determined.

At operation 1070, a difference between the change of the first group of purchasers and the change of the second group of purchasers can be identified.

At operation 1080, the change of the second group can be subtracted from the change of the first group, thereby generating an adjusted change of the first group.

It is contemplated that the operations of method 1000 may incorporate any of the other features disclosed herein.

It is contemplated that any features of any embodiments disclosed herein can be combined with any other features of any other embodiments disclosed herein. Accordingly, these any such hybrid embodiments are within the scope of the present disclosure.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

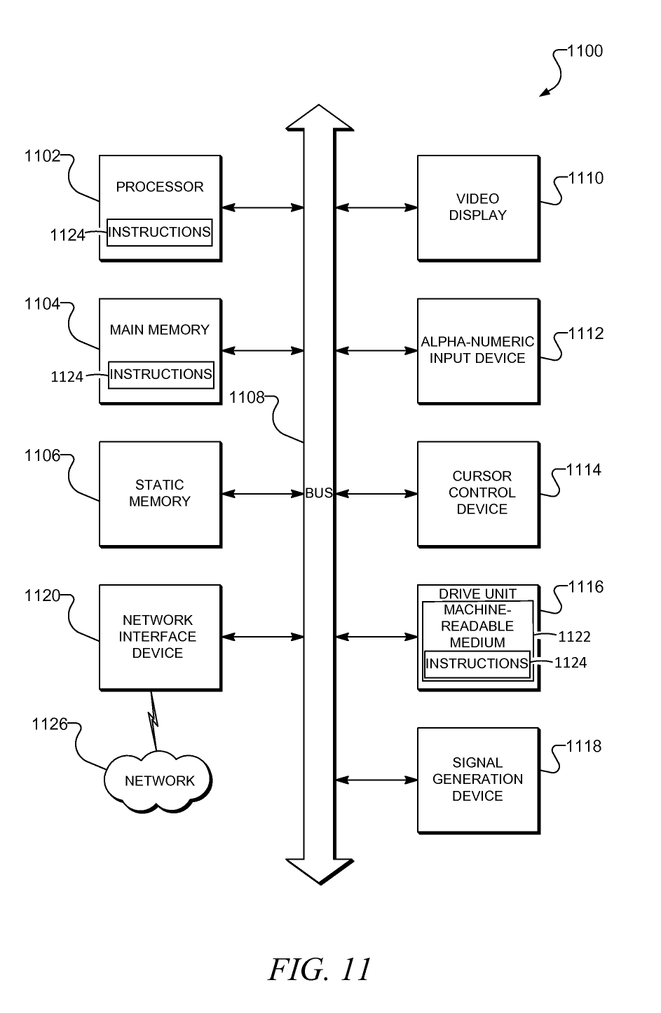

FIG. 11 is a block diagram of a machine in the example form of a computer system 1100 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU) or both), a main memory 1104 and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard), a user interface (UI) navigation (or cursor control) device 1114 (e.g., a mouse), a disk drive unit 1116, a signal generation device 1118 (e.g., a speaker), and a network interface device 1120.

### Machine-Readable Medium

The disk drive unit 1116 includes a machine-readable medium 1122 on which is stored one or more sets of data structures and instructions 1124 (e.g., software) embodying or utilized by any one or more of the methodologies or functions described herein. The instructions 1124 may also reside, completely or at least partially, within the main memory 1104 and/or within the processor 1102 during execution thereof by the computer system 1100, the main memory 1104 and the processor 1102 also constituting machine-readable media. The instructions 1124 may also reside, completely or at least partially, within the static memory 1106.

While the machine-readable medium 1122 is shown in an example embodiment to be a single medium, the term “machine-readable medium” may include a single medium or multiple media (e.g., a centralized or distributed database, and/or associated caches and servers) that store the one or more instructions 1124 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 1124 may further be transmitted or received over a communications network 1126 using a transmission medium. The instructions 1124 may be transmitted using the network interface device 1120 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented method comprising:
receiving advertisement information, the advertisement information comprising identifying information of an online advertisement for a product or a brand of products, identifying information of a plurality of recipients of the online advertisement, and a corresponding advertisement time at which the online advertisement was provided to each one of the plurality of recipients;
receiving purchase information for a plurality of offline purchases corresponding to at least one brick- and mortar retailer, the purchase information comprising identifying information of a corresponding purchaser for each one of the plurality of offline purchases, identifying information of a corresponding product or brand of products for each one of the plurality of offline purchases, and a corresponding purchase time at which each one of the plurality of offline purchases was made;
identifying one of the purchasers as one of the recipients based on a determined match between their corresponding identifying information; and
associating, by a machine having a memory and at least one processor, at least one of the plurality of purchases of the identified purchaser with the online advertisement based on:
a determination that the corresponding product of the at least one of the plurality of purchases corresponds to the product or brand of products of the online advertisement; and
a determination that the corresponding purchase time of the at least one of the plurality of purchases was after the corresponding advertisement time of the online advertisement.

2. The method of claim 1, wherein the identifying information of each recipient comprises a physical address and the identifying information of each purchaser comprises a physical address.

3. The method of claim 1, further comprising storing the association between the at least one of the purchases of the identified purchaser with the at least one online advertisement in a database.

4. The method of claim 1, further comprising modifying an advertising campaign based on the association between the at least one of the purchases of the identified purchaser with the online advertisement.

5. The method of claim 4, wherein modifying the advertising campaign comprises increasing a number of recipients to which the online advertisement is to be provided.

6. The method of claim 1, wherein the purchase information for the plurality of offline purchases is received from the corresponding at least one brick- and mortar retailer.

7. The method of claim 1, further comprising generating a human-readable report indicating the association between the at least one of the purchases of the identified purchaser with the online advertisement.

8. The method of claim 1, further comprising:
identifying a first group of the plurality of purchasers that were provided the online advertisement;
identifying a second group of the plurality of purchasers that were not provided the online advertisement;
determining pre-advertisement purchase behavior with respect to the product or the brand of products for the first group and the second group of purchasers corresponding to a period of time before the online advertisement was provided to the first group of purchasers;
determining post-advertisement purchase behavior with respect to the product or the brand of products for the first group and the second group of purchasers corresponding to a period of time after the online advertisement was provided to the second group of purchasers;
determining a change between the pre-advertisement purchase behavior of the first group of purchasers and the post-advertisement purchase behavior of the first group of purchasers;
determining a change between the pre-advertisement purchase behavior of the second group of purchasers and the post-advertisement purchase behavior of the second group of purchasers; and
identifying a difference between the change of the first group of purchasers and the change of the second group of purchasers.

9. The method of claim 8, further comprising subtracting the change of the second group from the change of the first group, thereby generating an adjusted change of the first group.

10. A system comprising:
a machine having a memory and at least one processor; and
an attribution module, executable by the machines, configured to:
receive advertisement information, the advertisement information comprising identifying information of an online advertisement for a product or a brand of products, identifying information of a plurality of recipients of the online advertisement, and a corresponding advertisement time at which the online advertisement was provided to each one of the plurality of recipients;
receive purchase information for a plurality of offline purchases corresponding to at least one brick- and mortar retailer, the purchase information comprising identifying information of a corresponding purchaser for each one of the plurality of offline purchases, identifying information of a corresponding product or brand of products for each one of the plurality of offline purchases, and a corresponding purchase time at which each one of the plurality of offline purchases was made;
identify one of the purchasers as one of the recipients based on a determined match between their corresponding identifying information; and
associate at least one of the plurality of purchases of the identified purchaser with the online advertisement based on:
a determination that the corresponding product of the at least one of the plurality of purchases corresponds to the product or brand of products of the online advertisement; and
a determination that the corresponding purchase time of the at least one of the plurality of purchases was after the corresponding advertisement time of the online advertisement.

11. The system of claim 10, wherein the identifying information of each recipient comprises a physical address and the identifying information of each purchaser comprises a physical address.

12. The system of claim 10, wherein the attribution module is further configured to store the association between the at least one of the purchases of the identified purchaser with the at least one online advertisement in a database.

13. The system of claim 10, wherein the attribution module is further configured to modify an advertising campaign based on the association between the at least one of the purchases of the identified purchaser with the online advertisement.

14. The system of claim 13, wherein the attribution module is further configured to modify the advertising campaign by increasing a number of recipients to which the online advertisement is to be provided.

15. The system of claim 10, wherein the purchase information for the plurality of offline purchases is received from the corresponding at least one brick- and mortar retailer.

16. The system of claim 10, wherein the attribution module is further configured to generate a human-readable report indicating the association between the at least one of the purchases of the identified purchaser with the online advertisement.

17. The system of claim 10, wherein the attribution module is further configured to:
identify a first group of the plurality of purchasers that were provided the online advertisement;
identify a second group of the plurality of purchasers that were not provided the online advertisement;
determine pre-advertisement purchase behavior with respect to the product or the brand of products for the first group and the second group of purchasers corresponding to a period of time before the online advertisement was provided to the first group of purchasers;
determine post-advertisement purchase behavior with respect to the product or the brand of products for the first group and the second group of purchasers corresponding to a period of time after the online advertisement was provided to the second group of purchasers;
determine a change between the pre-advertisement purchase behavior of the first group of purchasers and the post-advertisement purchase behavior of the first group of purchasers;
determine a change between the pre-advertisement purchase behavior of the second group of purchasers and the post-advertisement purchase behavior of the second group of purchasers; and
identify a difference between the change of the first group of purchasers and the change of the second group of purchasers.

18. The system of claim 17, wherein the attribution module is further configured to subtract the change of the second group from the change of the first group, thereby generating an adjusted change of the first group.

19. A non-transitory machine-readable storage medium storing a set of instructions that, when executed by at least one processor, causes the at least one processor to perform a set of operations comprising:
receiving advertisement information, the advertisement information comprising identifying information of an online advertisement for a product or a brand of products, identifying information of a plurality of recipients of the online advertisement, and a corresponding advertisement time at which the online advertisement was provided to each one of the plurality of recipients;
receiving purchase information for a plurality of offline purchases corresponding to at least one brick- and mortar retailer, the purchase information comprising identifying information of a corresponding purchaser for each one of the plurality of offline purchases, identifying information of a corresponding product or brand of products for each one of the plurality of offline purchases, and a corresponding purchase time at which each one of the plurality of offline purchases was made;
identifying one of the purchasers as one of the recipients based on a determined match between their corresponding identifying information; and
associating at least one of the plurality of purchases of the identified purchaser with the online advertisement based on:
a determination that the corresponding product of the at least one of the plurality of purchases corresponds to the product or brand of products of the online advertisement; and
a determination that the corresponding purchase time of the at least one of the plurality of purchases was after the corresponding advertisement time of the online advertisement.

20. The non-transitory machine-readable storage medium of claim 19, wherein the identifying information of each recipient comprises a physical address and the identifying information of each purchaser comprises a physical address.
